(19) United States
(12) Patent Application Publication
(10) Pub. No.: US 2026/0244483 A1
(43) Pub. Date: Aug. 20, 2026

(54) HARDWARE ASSISTED REAL TIME OPERATING SYSTEM (RTOS) SCHEDULER FOR MULTI-PROCESSOR SYSTEM

(71) Applicant: QUALCOMM Incorporated, San Diego, CA (US)

(72) Inventors: Zhiping HU, San Diego, CA (US); Kun MA, Skillman, NJ (US); Jeremy GILBERT, San Diego, CA (US); Suresh Kumar VENKUMAHANTI, Austin, TX (US)

(21) Appl. No.: 19/053,738

(22) Filed: Feb. 14, 2025

(51) Int. Cl. G06F 9/48; G06F 9/30

(52) U.S. Cl. CPC G06F 9/4818; G06F 9/30101

(57) ABSTRACT

Aspects of the disclosure are directed to a hardware-assisted real time operating system (RTOS) task scheduler. In accordance with one aspect, the disclosure includes determining a highest priority value of a plurality of pending tasks among a searchable set of processing engines using a hardware processor; comparing each of a plurality of executing priority values associated with a plurality of executing tasks for each of the searchable set of processing engines against the highest priority value to determine if a preemption interrupt should be generated; and executing the preemption interrupt for one of the plurality of executing tasks, wherein the one of the plurality of executing tasks has an executing priority value having a lower priority value than the highest priority value of the plurality of pending tasks.

### TECHNICAL FIELD

This disclosure relates generally to the field of information processing systems, and, in particular, to real time operating system (RTOS) scheduler in an information processing system.

### BACKGROUND

An information processing system may include multiple processing engines, processors or processing cores for a variety of user applications. An information processing system may include a plurality of processors, as well as input/output interfaces, a hierarchy of memory units and associated interconnection databuses. The plurality of processors may execute simultaneously on a plurality of tasks using a real time operating system (RTOS). A central issue for the RTOS is rapid scheduling among the plurality of tasks with different prioritization.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a hardware-assisted real time operating system (RTOS) task scheduler. Accordingly, the present disclosure discloses a method including: determining a highest priority value of a plurality of pending tasks among a searchable set of processing engines using a hardware processor; comparing each of a plurality of executing priority values associated with a plurality of executing tasks for each of the searchable set of processing engines against the highest priority value to determine if a preemption interrupt should be generated; and executing the preemption interrupt for one of the plurality of executing tasks, wherein the one of the plurality of executing tasks has an executing priority value having a lower priority value than the highest priority value of the plurality of pending tasks.

Another aspect of the disclosure provides an apparatus including: a bitmask of cores register configured to be set with at least one bitmask of at least one processing engine wherein the at least one processing engine is searched and monitored; a priority of best ready task register configured to be set a highest priority value of a pending task which is able to run on the at least one processing engine indicated by the bitmask of cores register; and a priority comparison unit configured to compare a first content against a second content of the priority of best ready task register.

Another aspect of the disclosure provides an apparatus including: a hardware processor; means for determining a highest priority value of a plurality of pending tasks among a searchable set of processing engines using the hardware processor with no software intervention; means for comparing each of a plurality of executing priority values associated with a plurality of executing tasks for each of the searchable set of processing engines against the highest priority value to determine if a preemption interrupt should be generated; and means for executing the preemption interrupt for one of the plurality of executing tasks, wherein the one of the plurality of executing tasks has an executing priority value having a lower priority value than the highest priority value of the plurality of pending tasks.

These and other aspects of the present disclosure will become more fully understood upon a review of the detailed description which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example block diagram of a single hardware searcher system.

FIG. 3 illustrates an example block diagram of a multiple hardware searcher system.

FIG. 4 illustrates an example flow diagram for implementing a hardware-assisted real time operating system (RTOS) task scheduler.

### DETAILED DESCRIPTION

The detailed description set forth below in connection with the appended drawings is intended as a description of various configurations and is not intended to represent the only configuration in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), uses multiple levels of coordination or synchronization. In one example, a slice may include a processing engine (i.e., a subset of the computing system) as well as associated memory units and other peripheral devices. In one example, execution of an application may be decomposed into a workload which is executed by multiple slices or multiple processing engines.

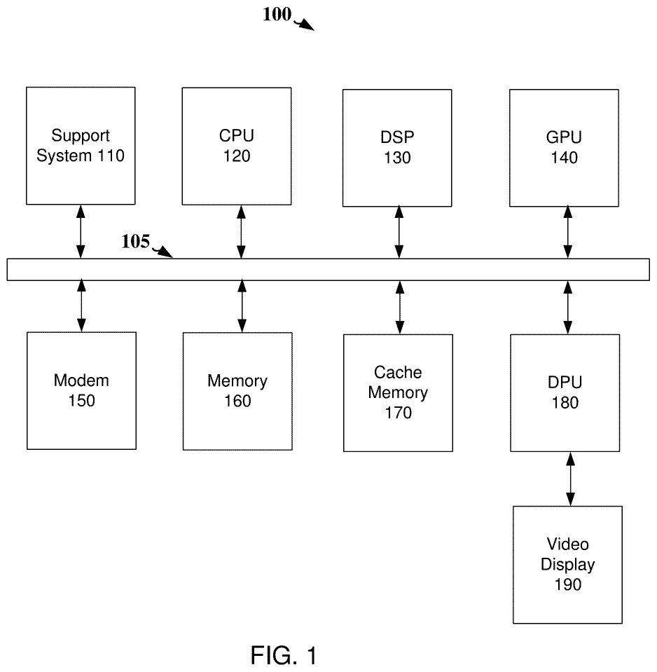

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. In one example, the CPU 120 may serve as a controller or a microcontroller of other processing engines. In one example, the controller or microcontroller may reallocate tasks from one processing engine to another. In one example, the controller or microcontroller may determine if a baseline workload partition should be reallocated using machine learning (ML) monitoring of system on a chip (SOC) temperatures.

In one example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. Although several components of the information processing system 100 are included herein, one skilled in the art would understand that the components listed herein are examples and are not exclusive. Thus, other components may be included as part of the information processing system 100 within the spirit and scope of the present disclosure.

In one example, one or more processing engines in the information processing system 100 may be aggregated into a single integrated circuit known as a system on a chip (SOC). In one example, the SOC may include the central processing unit (CPU) 120 and other processing engines such as the DSP 130 or the GPU 140. The SOC may also include the memory 160 and the cache memory 170.

In one example, the information processing system 100 may be part of a wireless device in a wireless communication system. For example, the wireless communication system may conform to a wireless network protocol such as 4G LTE (long term evolution), 5G NR (new radio), etc.

In one example, an information processing system may have a plurality of processing engines or a multi-processor system with a shared operating system (OS) for overall management and scheduling of a plurality of tasks. For example, a workload for the information processing system may be a plurality of tasks which are distributed among the plurality of processing engines. In one example, the information processing system is a symmetric multiprocessing (SMP) system with a plurality of processing engines and a shared main memory.

In one example, the shared operating system is a real time operating system (RTOS). For example, the RTOS is characterized by having timing constraints on execution of tasks. In one example, the RTOS includes task prioritization (i.e., each task has an assigned task priority for execution by the plurality of processing engines). In one example, an RTOS scheduler performs priority-based task scheduling for the plurality of tasks. In one example, the RTOS scheduler performs priority-based task scheduling such that a quantity of N tasks with highest priority are assigned to execute on N processing engines, where N is an integer count of processing engines.

In one example, the RTOS scheduler shares scheduler data for executing tasks, pending tasks and waiting/suspended tasks among the plurality of processing engines. In one example, an executing task is a task which is currently being serviced (i.e., acted on) by a processing engine. In one example, a pending task is a task which is currently awaiting servicing by a processing engine. In one example, a waiting/suspended task is a task which was previously an executing task but is currently halted.

In one example, scheduler data may be located either in kernel space (i.e., memory space allocated to the RTOS) or user space (i.e., memory space allocated to users). In one example, when a selected scheduler on one processing engine needs to access or modify shared scheduler data, it may require a mutual exclusion (mutex) lock first. For example, a mutex lock prevents other processing engines from accessing or modifying shared scheduler data simultaneously with the selected scheduler. For example, if another scheduler needs to access or modify scheduler data, it needs to wait for the mutex lock to be released by the selected scheduler (i.e., the holder of the mutex lock). In one example, a plurality of pending tasks is orthogonal to a plurality of executing tasks. That is, orthogonal is defined as separate and non-overlapping such that the plurality of pending tasks is separate and non-overlapping with the plurality of executing tasks.

In one example, if all tasks are set with a non-core affinity (i.e., all tasks may be executed on any processing engine), when a pending task is ready to execute, the RTOS scheduler compares the priority of the pending task against priorities of currently executing tasks on the plurality of processing engines. In one example, the RTOS scheduler first determines a lowest priority task and compares the pending task to it. For example, if the pending task has a higher priority than the lowest priority task, the RTOS scheduler preempts the lowest priority task by sending an inter-processor interrupt (IPI) signal to the corresponding processing engine for the lowest priority task. In one example, the RTOS scheduler offloads the lowest priority task and loads the pending task to run on a processing engine.

In one example, the step of comparing the priority of the pending task against priorities of currently executing tasks may be time intensive and power consuming in the RTOS scheduler. In one example, the RTOS scheduler retrieves priority data of currently executing tasks on each processing engine of the plurality of processing engines and performs a comparison operation individually by a software process. For example, determining a lowest priority task among the plurality of processing engines is desired for many RTOS scheduler functions for a multi-processor system (i.e., the determination operation is executed frequently). In one example, when the RTOS scheduler performs the determination operation for one processing engine, it needs to maintain the mutex lock to ensure integrity of the scheduler data from disruption by other processing engines.

In one example, a time latency of mutex lock maintenance by one processing engine affects the speed of scheduling operations on all other processing engines which are waiting for mutex release for their scheduling operations. As the quantity of processing engines increases, time latency on the comparison operation increases since more comparison operations are required on more processing engines. In addition, average latency for acquiring mutex lock on each processing engine for the RTOS scheduler to access shared scheduler data increases.

In one example, the RTOS scheduler supports a core-affinity setting for tasks. For example, each task sets its core-affinity index with a core bitmask for selected processing engines. For example, each core bitmask may be treated as a group of available processing engines for task execution. In one example, when a pending task is ready for execution, the RTOS scheduler needs to compare its priority against a plurality of priorities for the currently executing tasks for available processing engines assigned to the pending task. In one example, the RTOS scheduler determines if the pending task has a higher priority than the lowest priority task and preempts the lowest priority task by sending an inter-processor interrupt (IPI) signal to the corresponding processing engine for the lowest priority task. In one example, the RTOS scheduler offloads the lowest priority task and loads the pending task to run on a processing engine.

In one example, the lowest priority task is moved out of an execution state and becomes a new pending task. The RTOS scheduler next compares its priority against priorities of other tasks assigned to its corresponding processing engine. In one example, if the new pending task has a higher priority than the lowest priority task of its corresponding processing engine, the RTOS scheduler preempts the lowest priority task by sending an inter-processor interrupt (IPI) signal to the corresponding processing engine for the lowest priority task. In one example, the RTOS scheduler offloads the lowest priority task and loads the new pending task to run on a processing engine.

In one example, the RTOS scheduler repeats the comparison operation until all currently executing tasks have a higher priority than any pending tasks. In one example, for the RTOS scheduler which supports a core-affinity index for scheduling tasks, more priority comparisons may be needed than for supporting non-core-affinity index task scheduling.

Therefore, due to the negative impact on RTOS scheduler latency, it is important to complete the operation of determining a lowest priority task quickly and efficiently for the plurality of processing engines. In one example, when the lowest priority task is found to be at a lower priority of a pending task, the pending task is preempted quickly by sending an interrupt signal to the corresponding processing engine for a task context switch.

In one example, a hardware-based searcher may rapidly search a lowest priority task within a plurality of processing engines which are executing a plurality of tasks. In one example, the hardware-based searcher quickly sends an interrupt signal to preempt the lowest priority task on its corresponding processing engine when the lowest priority task is found to be at a lower priority than the priority of a pending task.

In one example, the hardware-based searcher first prepares a core register (e.g., a priority of running task register) for each processing engine of a plurality of processing engines. In one example, the core register for a particular processing engine is set with a priority value of an executing task for the particular processing engine.

In one example, the hardware-based searcher includes the following components:
priority of running task register—a register which is set with a priority of an executing task on a processing engine.
bitmask of cores register—a register which is set with a bitmask of a processing engine which the hardware-based searcher should search and monitor.
priority of best ready task register—a register which is set with a highest priority value of a pending task which is able to run on the processing engine indicated by the bitmask of cores register.
interrupt of preemption register—a register which is set with an interrupt number used for interrupting a processing engine for preemption of an executing task.
priority comparison unit—a hardware unit which compares contents of the bitmask of cores register with contents of the priority of best ready task register.
interrupt triggering unit—a hardware unit which accepts an output from the priority comparison unit and provides an interrupt output to preempt the lowest priority executing task.

In one example, the hardware-based searcher may also adjust priorities of a subset of processing engines temporarily for improved interrupt handling for preemption of tasks. For example, if one processing engine is not in a ready state for reception of interrupts, the hardware-based searcher may raise a task priority value in the one processing engine to a higher priority value (or the highest priority value) temporarily until the one processing engine is in the ready state for reception of interrupts. For example, if the task priority value is not lower than the value in the priority of best ready task register, the hardware-based searcher will not raise a preemption interrupt to the processing engine until the processing engine is ready to receive an interrupt with lowering its task priority value back to an original priority value.

For example, if a processing engine receives an interrupt and has not completed interrupt processing for task preemption, the task priority in the processing engine may also be raised by the hardware-based searcher to a higher priority value (or the highest priority value) temporarily until the processing engine is ready to receive an interrupt. For example, if the task priority value in the processing engine is not lower than the value in the priority of best ready task register, the hardware-based searcher will not raise a preemption interrupt to the processing engine until the processing engine is ready to receive an interrupt with lowering its task priority value back to an original priority value.

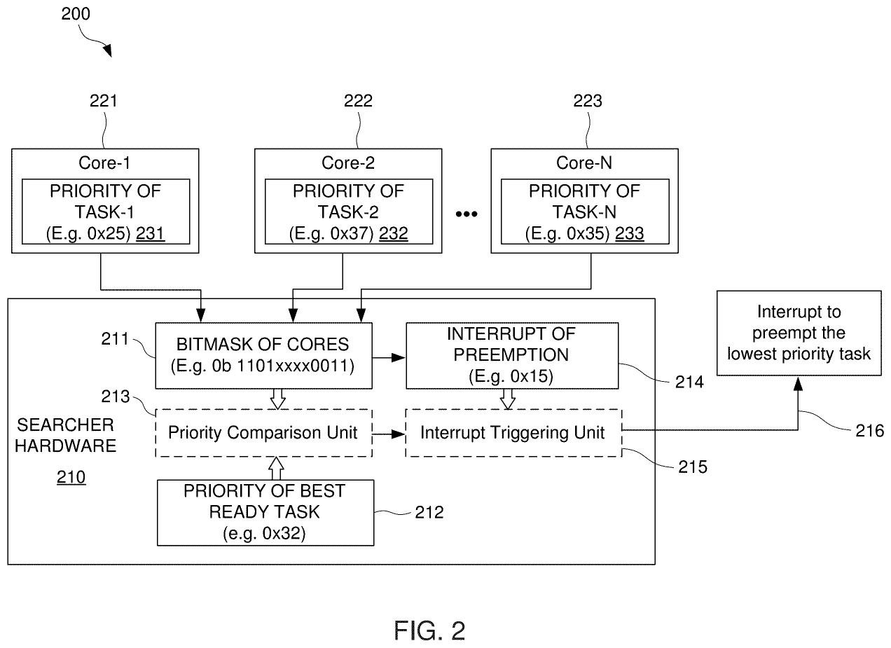

FIG. 2 illustrates an example block diagram 200 of a single hardware searcher system. In one example, the single hardware searcher system 200 includes a searcher hardware unit 210. In one example, the searcher hardware unit 210 includes a bitmask of cores register 211, a priority of best ready task register 212, a priority comparison unit 213, an interrupt of preemption register 214 and an interrupt triggering unit 215. In one example, the single hardware searcher 200 includes a first processing engine (e.g., core-1) 221, a second processing engine (e.g., core-2) 222, and so on until an Nth processing engine (e.g., core-N) 223. In one example, the first processing engine 221 includes a first priority of running task register 231, the second processing engine 222 includes a second priority of running task register 232, and the Nth processing engine 223 includes an Nth priority of running task register 233.

In one example, the interrupt triggering unit 215 generates an interrupt signal 216. In one example, the interrupt signal 216 is used to preempt a lowest priority task in a plurality of executing tasks. In one example, the searcher hardware unit 210 may be implemented on a separate chip. In one example, the searcher hardware unit 210 may be implemented on a processing engine chip.

In one example, RTOS software sets a priority of running task register (e.g., priority of running task register 231, second priority of running task register 232 and Nth priority of running task register 233) to a priority value of each processing engine of the plurality of processing engines. In one example, RTOS software sets the bitmask of cores register 211 to a bitmask value to indicate which processing engine (i.e., indicated processing engines) should be searched and monitored. In one example, RTOS software sets the priority of best ready task register 212 to a highest priority value of a pending task which may be executed on indicated processing engines according to the bitmask value. In one example, the bitmask value includes a plurality of enabled digits (e.g., values of one) in the bitmask of cores register 211 to identify indicated processing engines subject to searching and monitoring.

In one example, RTOS software sets the interrupt of preemption register 214 with an interrupt value used for interrupting a processing engine for preemption of a running task. In one example, the searcher hardware unit 210 continually searches and monitors a lowest priority task running on the indicated processing engines specified by the bitmask of cores register 211. In one example, the searcher hardware unit 210 compares the lowest priority with the highest priority value of a pending task.

If the lowest priority is lower than the highest priority value, a preemption interrupt with the interrupt value set by the interrupt of preemption register 214 is propagated for preempting the lowest priority task. In one example, upon receiving the preemption interrupt, the RTOS software makes a context switch on the corresponding processing engine. In one example, the pending task with the highest priority value of pending tasks is promoted to a promoted executing task. In one example, the one determined executing task is demoted to a demoted pending task.

In one example, the searcher hardware unit may also adjust priorities of certain processing engines temporarily for improved interrupt handling for preempting software tasks. In one example, if a processing engine is not in a state ready for interrupt reception, the searcher hardware unit may raise a task priority value of the processing engine to a higher priority value (or the highest priority value) temporarily until the processing engine is ready to receive an interrupt. For example, if the task priority value is not lower than the value in the priority of best ready task register, the hardware-based searcher will not raise a preemption interrupt to the processing engine until the processing engine is ready to receive an interrupt with lowering its task priority value back to an original priority value.

For example, if a processing engine receives an interrupt and has not completed interrupt processing for task preemption, the task priority in the processing engine may also be raised by the hardware-based searcher to a higher priority value (or the highest priority value) temporarily until the processing engine is ready to receive an interrupt. For example, if the task priority value in the processing engine is not lower than the value in the Priority of best ready task register, the hardware-based searcher will not raise a preemption interrupt to the processing engine until the processing engine is ready to receive an interrupt with lowering its task priority value back to an original priority value.

In one example, with the searcher hardware unit in the RTOS software, overhead or workload of software functions in the scheduler may be greatly reduced since the searcher hardware unit does not need to search the lowest priority task with a plurality of processing engines with a plurality of tasks. In one example, the RTOS software does not need to raise a preemption interrupt when a lowest priority is determined to be lower than a ready task priority. In one example, RTOS software execution speed may be increased with improved scheduler performance.

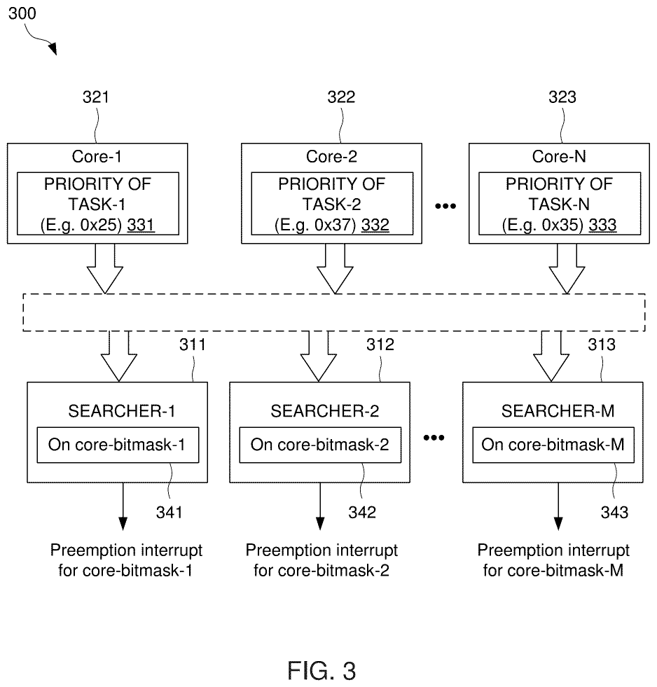

FIG. 3 illustrates an example block diagram 300 of a multiple hardware searcher system. In one example, the multiple hardware searcher system 300 may support scheduling software tasks with a plurality of different core-affinity settings. In one example, the multiple hardware searcher system 300 includes a first searcher hardware unit 311, a second searcher hardware unit 312, and so on until an Mth searcher hardware unit 313. In one example, the first searcher hardware unit 311 includes a first bitmask of cores register 341, the second searcher hardware unit 312 includes a second bitmask of cores register 342 and the Mth searcher hardware unit 313 includes an Mth bitmask of cores register 343.

In one example, the multiple hardware searcher system 300 includes a first processing engine (e.g., core-1) 321, a second processing engine (e.g., core-2) 322, and so on until an Nth processing engine (e.g., core-N) 323. In one example, the first processing engine 321 includes a first priority of running task register 331, the second processing engine 322 includes a second priority of running task register 332, and the Nth processing engine 323 includes an Nth priority of running task register 333.

In one example, if there are a plurality of M different core affinity bitmasks used by a plurality of software tasks in a symmetric multiprocessing (SMP) system, the multiple hardware searcher system 300 may prepare a quantity of M searcher hardware units for supporting the plurality of M different core affinity bitmasks for the plurality of software tasks.

In one example, a first plurality of software tasks may set their core affinity with a first bitmask value. For example, the RTOS software may set the first bitmask of cores register 341 with the first bitmask value so that the first searcher hardware unit 311 may search and monitor task priorities running on the processing engines indicated by the first bitmask value. In one example, the RTOS software sets a first priority of best ready task register in the first searcher hardware unit 311 to the highest priority value of a pending task which may be executed on processing engines indicated by the first bitmask of cores register 341 in the first searcher hardware unit 311. In one example, the RTOS software sets an interrupt number into an interrupt of preemption register in the first searcher hardware unit 311 which is used for preemption of a low priority task among the processing engines indicated by the first bitmask of cores register 341 in the first searcher hardware unit 311.

In one example, a second plurality of software tasks may set their core affinity with a second bitmask value. For example, the RTOS software may set the second bitmask of cores register 342 with the second bitmask value so that the second searcher hardware unit 312 may search and monitor task priorities running on the processing engines indicated by the second bitmask value. In one example, the RTOS software sets a second priority of best ready task register in the second searcher hardware unit 312 to the highest priority value of a pending task which may be executed on processing engines indicated by the second bitmask of cores register 342 in the second searcher hardware unit 312. In one example, the RTOS software sets an interrupt number into an interrupt of preemption register in the second searcher hardware unit 312 which is used for preemption of a low priority task among the processing engines indicated by the second bitmask of cores register 342 in the second searcher hardware unit 312.

In one example, an Mth plurality of software tasks may set their core affinity with an Mth bitmask value. For example, the RTOS software may set the Mth bitmask of cores register 343 with the Mth bitmask value so that the Mth searcher hardware unit 313 may search and monitor task priorities running on the processing engines indicated by the Mth bitmask value. In one example, the RTOS software sets an Mth priority of best ready task register in the Mth searcher hardware unit 313 to the highest priority value of a pending task which may be executed on processing engines indicated by the Mth bitmask of cores register in the Mth searcher hardware unit 313. In one example, the RTOS software sets an interrupt number into an interrupt of preemption register in the Mth searcher hardware unit 313 which is used for preemption of a low priority task among the processing engines indicated by the Mth bitmask of cores register in the Mth searcher hardware unit 313.

In one example, the RTOS software sets a priority of running task register on every processing engine to a priority value of an executing task on each processing engine. In one example, the first searcher hardware unit 311 keeps searching and monitoring the lowest priority task executing on the processing engines specified by the first bitmask of cores register 341 and compares the lowest priority value with a first priority of best ready task register in the first searcher hardware unit 311. In one example, if the lowest priority value is lower than the first priority of best ready task register, a preemption interrupt with the interrupt number set by the first interrupt of preemption register is raised for preempting with the lowest priority task.

In one example, the second searcher hardware unit 312 keeps searching and monitoring the lowest priority task executing on the processing engines specified by the second bitmask of cores register 342 and compares the lowest priority value with a second priority of best ready task register in the second searcher hardware unit 312. In one example, if the lowest priority value is lower than the second priority of best ready task register, a preemption interrupt with the interrupt number set by the second interrupt of preemption register is raised for preempting with the lowest priority task.

In one example, as a first optimization option, there may be a plurality of preemption interrupts from a plurality of searcher hardware units which are raised simultaneously and target to the same processing engine. For example, the plurality of preemption interrupts may occur when the priority of running task register on a processing engine is set to a priority value lower than the priority of best ready task register on the plurality of searcher hardware units.

For example, to simplify and reduce scheduler functions overhead, the plurality of searcher hardware units may compare priorities in each priority of best ready task register in the plurality of searcher hardware units which will raise an interrupt. In one example, the multiple hardware searcher system 300 may determine the searcher hardware unit which has the highest priority value in its priority of best ready task register and only allow the determine searcher hardware unit to raise a preemption interrupt for the corresponding core bitmask first. For example, the multiple hardware searcher system 300 may postpone each other searcher hardware units from triggering their respective preemption interrupt.

In one example, after a quantity of processor clock cycles (for example, to allow the preemption interrupt to be sent out and/or received by a processing engine) the multiple hardware searcher system 300 may then allow a second preemption interrupt to be triggered from another searcher hardware unit. In one example, the second preemption interrupt may be triggered if its corresponding priority of best ready task register has a priority value than a running task priority value of a priority of running task register at that time.

In one example, the multiple hardware searcher system 300 repeats the above sequence of operations until the priority value of the priority of best ready task register on all relevant searcher hardware units is lower than the running task priority of the priority of running task register for all processing engines for their corresponding bitmasks.

In one example, as second optimization option, an ordering of raising multiple preemption interrupts from a plurality of searcher hardware units may be adjusted to improve a task arrangement on the plurality of processing engines. In one example, the multiple hardware searcher system 300 may compare and schedule a plurality of preemption interrupts based on both the contents of all priority of running task registers in all relevant processing engines and the contents of all priority of best ready task registers in all relevant searcher hardware units. In one example, the multiple hardware searcher system 300 may raise the preemption interrupts in an optimized order.

In one example, the contents of the priority of running task registers for a quantity of three processing engines are as follows: first processing engine has 0x10, second processing engine has 0x20 and third processing engine has 0x30 (where 0x denotes a hexadecimal (i.e., base-16) notation). In one example, the contents of the priority of best ready task register for the first searcher hardware unit is 0x15 with a first bitmask including the first processing engine and the second processing engine. In one example, the contents of the priority of best ready task register for the second searcher hardware unit is 0x16 with a second bitmask including the second processing engine and the third processing engine.

In one example, if the priority value of best ready task register for the first processing engine and the second processing engine is a higher priority value than the priority value of the best ready task register for the second processing engine and the third processing engine, the second processing engine and the third processing engine may be preempted one by one for context switching to the two ready tasks in the first searcher hardware unit and the second searcher hardware unit. In one example, instead of raising a preemption interrupt for the first searcher hardware unit initially, the multiple hardware searcher system 300 may raise a preemption interrupt for the second searcher hardware unit to the third processing engine initially such that the third processing engine may accept the ready task of priority 0x16 of the second searcher hardware unit. In one example, the first searcher hardware unit may next raise the preemption interrupt to the second processing unit such that the second processing unit may accept the ready task of priority 0x15 of the first searcher hardware unit.

In one example, the contents of the priority of running task registers for a quantity of four processing engines are as follows: first processing engine has 0x10, second processing engine has 0x20, third processing engine has 0x30 and fourth processing engine has 0x40. In one example, the contents of the priority of best ready task register for the first searcher hardware unit is 0x15 with a first bitmask including the first processing engine and the second processing engine. In one example, the contents of the priority of best ready task register for the second searcher hardware unit is 0x16 with a second bitmask including the second processing engine and the third processing engine.

In one example, the contents of the priority of best ready task register for the third searcher hardware unit is 0x017 with a third bitmask including the third processing engine and the fourth processing engine. In one example, the third searcher hardware unit may raise the preemption interrupt to preempt the fourth processing engine. In one example, the second searcher hardware unit may next raise the preemption interrupt to preempt the third processing engine. In one example, the first searcher hardware unit may next raise the preemption interrupt to preempt the second processing engine.

In one example, the plurality of searcher hardware units and the RTOS scheduler may reduce overhead or workload of scheduler software functions, since the plurality of searcher hardware units offload the scheduler software from searching lowest priority tasks within the plurality of processing engines with a plurality of software tasks being executed. In one example, the scheduler software does not need to raise an inter-processor interrupt (IPI) interrupt when the lowest priority is determined to be lower that the ready task priority. In one example, usage of the plurality of searcher hardware units for offloading the scheduler software may speed up the RTOS scheduler processing and improve RTOS scheduler performance.

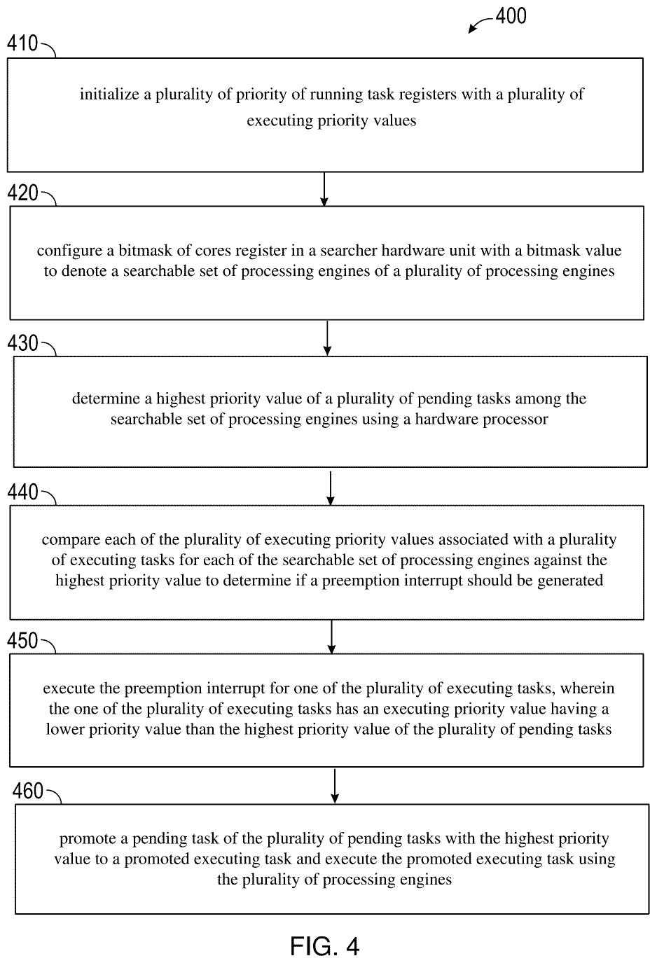

FIG. 4 illustrates an example flow diagram 400 for implementing a hardware-assisted real time operating system (RTOS) task scheduler. In block 410, initialize a plurality of priority of running task registers with a plurality of executing priority values. In one example, a plurality of priority of running task registers is initialized with a plurality of executing priority values. In one example, the plurality of executing priority values is associated with a plurality of executing tasks in a plurality of processing engines. In one example, each priority of running task register of the plurality of running task registers contains an executing priority value of an executing task on each processing engine. In one example, the executing priority value may be temporarily elevated to an elevated priority value if its associated processing engine is in a not ready state. In one example, the not ready state means that the associated processing engine is unable to process a preemption interrupt. In one example, the elevated priority value is replaced by the executing priority value after the associated processing engine is in a ready state. In one example, the ready state means that the associated processing engine is able to process a preemption interrupt.

In one example, the initialization of the plurality of priority of running tasks register is performed by a system controller or a central processing unit. In one example, the step of block 410 may be performed by one or more of the following: a processing engine, a central processing unit (CPU), a digital signal processor (DSP), a graphics processing unit (GPU), a display processing unit (DPU), a microcontroller, a microprocessor, etc.

In block 420, configure a bitmask of cores register in a searcher hardware unit with a bitmask value to denote a searchable set of processing engines of a plurality of processing engines. In one example, a bitmask of cores register in a searcher hardware unit is configured with a bitmask value to denote a searchable set of processing engines of a plurality of processing engines. In one example, the searchable set of processing engines is searched and monitored by the searcher hardware unit for priority-based task scheduling of the plurality of executing tasks. In one example, the bitmask value includes a plurality of enabled digits (e.g., values of one) in the bitmask of cores register to identify processing engines subject to searching and monitoring. In one example, the configuration of the bitmask of cores register is performed by the system controller or by the searcher hardware unit.

In one example, the searcher hardware unit is a plurality of searcher hardware units. In one example, the plurality of searcher hardware units includes a plurality of bitmask of cores registers with a plurality of bitmask values. In one example, the configuration of the bitmask of cores register is performed by the system controller or by the searcher hardware unit. In one example, the step of block 420 may be performed by one or more of the following: a processing engine, a central processing unit (CPU), a digital signal processor (DSP), a graphics processing unit (GPU), a display processing unit (DPU), a microcontroller, a microprocessor, etc.

In block 430, determine a highest priority value of a plurality of pending tasks among the searchable set of processing engines using a hardware processor. In one example, a highest priority value of a plurality of pending tasks among the searchable set of processing engines is determined using a hardware processor. In one example, the highest priority value is set into a priority of best ready task register in the searcher hardware unit. In one example, the highest priority value corresponds to a lowest integer value. In one example, the highest priority value corresponds to a highest integer value.

In one example, the plurality of pending tasks is orthogonal to the plurality of executing tasks. In one example, using a hardware processor (i.e., hardware processing) requires no software intervention. In one example, the determination of the highest priority value is performed by the system controller or by the searcher hardware unit. In one example, the step of block 430 may be performed by one or more of the following: a processing engine, a central processing unit (CPU), a digital signal processor (DSP), a graphics processing unit (GPU), a display processing unit (DPU), a microcontroller, a microprocessor, etc.

In block 440, compare each of the plurality of executing priority values associated with a plurality of executing tasks for each of the searchable set of processing engines against the highest priority value to determine if a preemption interrupt should be generated. In one example, each of the plurality of executing priority values associated with a plurality of executing tasks for each of the searchable set of processing engines is compared against the highest priority value to determine if a preemption interrupt should be generated.

In one example, the comparison uses only a hardware processor. In one example, the comparison of each executing priority value of the plurality of executing priority values is performed by determining if each of the plurality of executing priority value has a lower priority value than the highest priority value of the plurality of pending tasks. In one example, an executing priority value has a lower priority value if its integer value is greater than an integer value of the highest priority value. In one example, the comparison of each of the executing priority values is performed by the system controller or by the searcher hardware unit. In one example, the step of block 440 may be performed by one or more of the following: a processing engine, a central processing unit (CPU), a digital signal processor (DSP), a graphics processing unit (GPU), a display processing unit (DPU), a microcontroller, a microprocessor, etc.

In block 450, execute the preemption interrupt for one of the plurality of executing tasks, wherein the one of the plurality of executing tasks has an executing priority value having a lower priority value than the highest priority value of the plurality of pending tasks. In one example, the preemption interrupt is executed for one of the plurality of executing tasks, wherein the one of the plurality of executing tasks has an executing priority value having a lower priority value than the highest priority value of the plurality of pending tasks.

In one example, the execution uses only a hardware processor without any software intervention. In one example, the preemption interrupt sends a preemption interrupt signal to a processing engine associated with the one of the plurality of executing tasks. In one example, the preemption interrupt sends a preemption interrupt signal to a system. In one example, the system is a controller. In one example, the preemption interrupt is an inter-process interrupt (IPI) signal sent to the processing engine associated with the one of the plurality of executing tasks. In one example, the preemption interrupt incorporates an interrupt number contained in an interrupt of preemption register. In one example, the execution of the preemption interrupt is performed by the system controller or by the searcher hardware unit. In one example, the step of block 450 may be performed by one or more of the following: a processing engine, a central processing unit (CPU), a digital signal processor (DSP), a graphics processing unit (GPU), a display processing unit (DPU), a microcontroller, a microprocessor, etc.

In block 460, promote a pending task of the plurality of pending tasks with the highest priority value to a promoted executing task and execute the promoted executing task using the plurality of processing engines. In one example, a pending task of the plurality of pending tasks with the highest priority value is promoted to a promoted executing task and the promoted executing task is executed using the plurality of processing engines.

In one example, demote the one of the plurality of executing tasks to a demoted pending task. In one example, the promotion of the pending task of the plurality of pending tasks is performed by the system controller or by the searcher hardware unit. In one example, the step of block 460 may be performed by one or more of the following: a processing engine, a central processing unit (CPU), a digital signal processor (DSP), a graphics processing unit (GPU), a display processing unit (DPU), a microcontroller, a microprocessor, etc.

In one example, a method includes: determining a highest priority value of a plurality of pending tasks among a searchable set of processing engines using a hardware processor; comparing each of a plurality of executing priority values associated with a plurality of executing tasks for each of the searchable set of processing engines against the highest priority value to determine if a preemption interrupt should be generated; and executing the preemption interrupt for one of the plurality of executing tasks, wherein the one of the plurality of executing tasks has an executing priority value having a lower priority value than the highest priority value of the plurality of pending tasks.

In one example, the highest priority value is set into a priority of best ready task register in a searcher hardware unit. In one example, the plurality of pending tasks is orthogonal to the plurality of executing tasks. In one example, the using the hardware processor requires no software intervention. In one example, the comparing the each of the plurality of executing priority values uses the hardware processor and requires no software intervention.

In one example, the method further includes promoting a pending task of the plurality of pending tasks with the highest priority value to a promoted executing task; and executing the promoted executing task using a plurality of processing engines. In one example, the highest priority value corresponds to a lowest integer value.

In one example, the method further includes configuring a bitmask of cores register in a searcher hardware unit with a bitmask value to denote the searchable set of processing engines of the plurality of processing engines. In one example, the preemption interrupt sends a preemption interrupt signal, for example, to a processing engine associated with the one of the plurality of executing tasks. In one example, the preemption interrupt is an inter-process interrupt (IPI) signal, for example, sent to the processing engine.

In one example, the method further includes initializing a plurality of priority of running task registers with the plurality of executing priority values. In one example, the method further includes demoting the one of the plurality of executing tasks to a demoted pending task.

In one example, an apparatus including: a bitmask of cores register configured to be set with at least one bitmask of at least one processing engine wherein the at least one processing engine is searched and monitored; a priority of best ready task register configured to be set a highest priority value of a pending task which is able to run on the at least one processing engine indicated by the bitmask of cores register; and a priority comparison unit configured to compare a first content against a second content of the priority of best ready task register.

In one example, the apparatus further includes at least one priority of running task register configured to be set with at least one priority of an executing task on the at least one processing engine. In one example, the first content includes at least one content of at least one of a plurality of priority of running task registers.

In one example, an apparatus includes: a hardware processor; means for determining a highest priority value of a plurality of pending tasks among a searchable set of processing engines using the hardware processor with no software intervention; means for comparing each of a plurality of executing priority values associated with a plurality of executing tasks for each of the searchable set of processing engines against the highest priority value to determine if a preemption interrupt should be generated; and means for executing the preemption interrupt for one of the plurality of executing tasks, wherein the one of the plurality of executing tasks has an executing priority value having a lower priority value than the highest priority value of the plurality of pending tasks.

In one example, the apparatus further includes means for promoting a pending task of the plurality of pending tasks with the highest priority value to a promoted executing task; and means for executing the promoted executing task using a plurality of processing engines. In one example, the apparatus further includes means for configuring a bitmask of cores register in a searcher hardware unit with a bitmask value to denote the searchable set of processing engines of the plurality of processing engines. In one example, the apparatus further includes means for initializing a plurality of priority of running task registers with the plurality of executing priority values. In one example, the preemption interrupt sends a preemption interrupt signal to a processing engine associated with the one of the plurality of executing tasks.

In one aspect, one or more of the steps for providing a hardware-assisted real time operating system (RTOS) task scheduler in FIG. 4 may be executed by one or more processors which may include hardware, software, firmware, etc. The one or more processors, for example, may be used to execute software or firmware needed to perform the steps in the flow diagram of FIG. 4. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method comprising:
determining a highest priority value of a plurality of pending tasks among a searchable set of processing engines using a hardware processor;
comparing each of a plurality of executing priority values associated with a plurality of executing tasks for each of the searchable set of processing engines against the highest priority value to determine if a preemption interrupt should be generated; and
executing the preemption interrupt for one of the plurality of executing tasks, wherein the one of the plurality of executing tasks has an executing priority value having a lower priority value than the highest priority value of the plurality of pending tasks.

2. The method of claim 1, wherein the highest priority value is set into a priority of best ready task register in a searcher hardware unit.

3. The method of claim 1, wherein the plurality of pending tasks is orthogonal to the plurality of executing tasks.

4. The method of claim 1, wherein the using the hardware processor requires no software intervention.

5. The method of claim 1, wherein the comparing the each of the plurality of executing priority values uses the hardware processor and requires no software intervention.

6. The method of claim 5, further comprising:
promoting a pending task of the plurality of pending tasks with the highest priority value to a promoted executing task; and
executing the promoted executing task using a plurality of processing engines.

7. The method of claim 6, wherein the highest priority value corresponds to a lowest integer value.

8. The method of claim 6, further comprising configuring a bitmask of cores register in a searcher hardware unit with a bitmask value to denote the searchable set of processing engines of the plurality of processing engines.

9. The method of claim 8, wherein the preemption interrupt sends a preemption interrupt signal.

10. The method of claim 9, wherein the preemption interrupt is an inter-process interrupt (IPI) signal.

11. The method of claim 8, further comprising initializing a plurality of priority of running task registers with the plurality of executing priority values.

12. The method of claim 11, further comprising demoting the one of the plurality of executing tasks to a demoted pending task.

13. An apparatus comprising:
a bitmask of cores register configured to be set with at least one bitmask of at least one processing engine wherein the at least one processing engine is searched and monitored;
a priority of best ready task register configured to be set a highest priority value of a pending task which is able to run on the at least one processing engine indicated by the bitmask of cores register; and
a priority comparison unit configured to compare a first content against a second content of the priority of best ready task register.

14. The apparatus of claim 13, further comprising at least one priority of running task register configured to be set with at least one priority of an executing task on the at least one processing engine.

15. The apparatus of claim 14, wherein the first content includes at least one content of at least one of a plurality of priority of running task registers.

16. An apparatus comprising:
a hardware processor;
means for determining a highest priority value of a plurality of pending tasks among a searchable set of processing engines using the hardware processor with no software intervention;
means for comparing each of a plurality of executing priority values associated with a plurality of executing tasks for each of the searchable set of processing engines against the highest priority value to determine if a preemption interrupt should be generated; and
means for executing the preemption interrupt for one of the plurality of executing tasks, wherein the one of the plurality of executing tasks has an executing priority value having a lower priority value than the highest priority value of the plurality of pending tasks.

17. The apparatus of claim 16, further comprising:
means for promoting a pending task of the plurality of pending tasks with the highest priority value to a promoted executing task; and
means for executing the promoted executing task using a plurality of processing engines.

18. The apparatus of claim 17, further comprising means for configuring a bitmask of cores register in a searcher hardware unit with a bitmask value to denote the searchable set of processing engines of the plurality of processing engines.

19. The apparatus of claim 18, further comprising means for initializing a plurality of priority of running task registers with the plurality of executing priority values.

20. The apparatus of claim 19, wherein the preemption interrupt sends a preemption interrupt signal.
